(19) United States
(12) Patent Application Publication
(10) Pub. No.: US 2021/0101389 A1
(43) Pub. Date: Apr. 8, 2021

(54) MOBILE PRINTER USING FERROFLUIDS

(71) Applicant: International Business Machines Corporation, Armonk, NY (US)

(72) Inventors: MUKUNDAN SUNDARARAJAN, Bangalore (IN); SHILPA SHETTY, Bangalore (IN)

(21) Appl. No.: 16/590,474

(22) Filed: Oct. 2, 2019

(51) Int. Cl. B41J 2/43; B41J 2/175; B41J 3/60

(52) U.S. Cl. CPC B41J 2/43; B41J 3/60; B41J 2/175

(57) ABSTRACT

Described are techniques for ferrofluidic printing. The techniques including a method comprising receiving an electronic document at a ferrofluidic printer from a user device via a short-range network. The method further comprises applying a magnetic field to a ferrofluid to form a ferrofluidic template approximating a portion of the electronic document. The method further comprises projecting ink through the ferrofluidic template and onto a page using a blower.

### BACKGROUND

The present disclosure relates to printers, and, more specifically, to a mobile printer utilizing ferrofluids.

A variety of printers exist for various printing techniques including toner-based printers, liquid inkjet printers, solid ink printers, dye-sublimation printers, thermal printers, and others. Many printers include a print-head that traverses a page line-by-line while depositing ink. Other printers apply ink to a print drum which then transfers the ink to the page.

### SUMMARY

Aspects of the present disclosure are directed toward a method comprising receiving an electronic document at a ferrofluidic printer from a user device via a short-range network. The method further comprises applying a magnetic field to a ferrofluid to form a ferrofluidic template approximating a portion of the electronic document. The method further comprises projecting ink through the ferrofluidic template and onto a page using a blower.

Additional aspects of the present disclosure are directed to systems and computer program products configured to perform the method described above.

Additional aspects of the present disclosure are directed toward a ferrofluidic printer comprising a magnetic field generator configured to generate a magnetic field. The ferrofluidic printer further comprises a ferrofluidic template comprising a ferrofluid and configured to approximate a portion of an electronic document in response to the magnetic field. The ferrofluidic printer further comprises a blower configured to project ink particles through the ferrofluidic template. The ferrofluidic printer further comprises a block/pass layer configured to transition from a block mode to a pass mode after the magnetic field is generated and before the blower projects the ink particles through the ferrofluidic template.

The present summary is not intended to illustrate each aspect of, every implementation of, and/or every embodiment of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates an example ferrofluidic printer performing print operations, in accordance with some embodiments of the present disclosure.

FIG. 1B illustrates example components of a ferrofluidic printer, in accordance with some embodiments of the present disclosure.

FIG. 2A illustrates an example magnetic field generator, in accordance with some embodiments of the present disclosure.

FIG. 2B illustrates an example ferrofluidic template, in accordance with some embodiments of the present disclosure.

FIG. 2C illustrates an example block/pass layer, in accordance with some embodiments of the present disclosure.

FIG. 3 illustrates a flowchart of an example method for performing printing operations using a ferrofluidic printer, in accordance with some embodiments of the present disclosure.

FIG. 4 illustrates a flowchart of an example method for generating a magnetization profile for a document, in accordance with some embodiments of the present disclosure.

FIG. 5 illustrates a block diagram of an example computer, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward printers, and, more specifically, to a mobile printer utilizing ferrofluids. While not limited to such applications, embodiments of the present disclosure may be better understood in light of the aforementioned context.

Aspects of the present disclosure are directed toward a mobile printer utilizing ferrofluidic techniques to perform double-sided printing on a variety of page sizes using relatively fewer moving parts and having a compact design. Further, aspects of the present disclosure are capable of printing text, images, or a combination of text and images.

Regarding ferrofluidic techniques, aspects of the present disclosure can generate magnetic fields capable of forming a de-magnetized ferrofluid in a liquid state into a magnetized ferrofluid in a solid-like state that is used as a ferrofluidic template approximating a portion of a document to be printed (e.g., one line or several lines of characters in a text document). The present disclosure can subsequently project ink particles through the ferrofluidic template and onto a page to form the printed characters or images on the page. For example, aspects of the present disclosure can utilize a fan or blower to project the ink particles through the ferrofluidic template and onto the page. In some embodiments, aspects of the present disclosure include a cooling mechanism such as a circuit configured to realize the Peltier effect. The Peltier effect refers to an effect whereby heat is emitted or absorbed when an electric current passes across a junction between two materials. The cooling mechanism can cause condensation to form on the ink and/or the paper. The condensation can improve adhesion of the ink to the paper.

Regarding double-sided printing, aspects of the present disclosure can invert, mirror, flip, or otherwise manipulate alternative pages of a document to be properly printed on the reverse side of the page. Aspects of the present disclosure used for double-sided printing can include a second ferrofluidic printing apparatus realizing the ferrofluidic techniques discussed above for simultaneously printing on the bottom side of a page in the ferrofluidic printer. In such embodiments, the lower ferrofluidic printing apparatus can project the ink at a higher speed relative to the upper ferrofluidic printing apparatus in order to overcome the counteracting gravitational force.

Regarding a variety of page sizes, aspects of the present disclosure can be configured to print on numerous page sizes which may merely be limited according to the dimensions of the ferrofluidic printer itself. Further, aspects of the present disclosure can print pages of predetermined size (e.g., A4). This is useful for a mobile printer insofar as many mobile printers are relatively small in size because they can be limited to printing relatively smaller pages than other types of printers.

Regarding using relatively fewer moving parts in the ferrofluidic printer, this can improve reliability (e.g., fewer components subject to failure) and enable the printer to be more compact in size than other mobile printers. As previously discussed, the ferrofluidic techniques used to print are different from the printing techniques traditionally utilized. Advantageously, projecting ink through a ferrofluidic template is a space-efficient way to print while maintaining acceptable printing speed and acceptable print quality.

Regarding compact design, aspects of the present disclosure are configured to be easily transportable by a user. For example, a printer in accordance with some aspects of the present disclosure can have dimensions of equal to or less than approximately 305 millimeters (12 inches) wide by 51 millimeters (2 inches) tall by 51 millimeters (2 inches) long. Such a size can improve usability by being readily transportable.

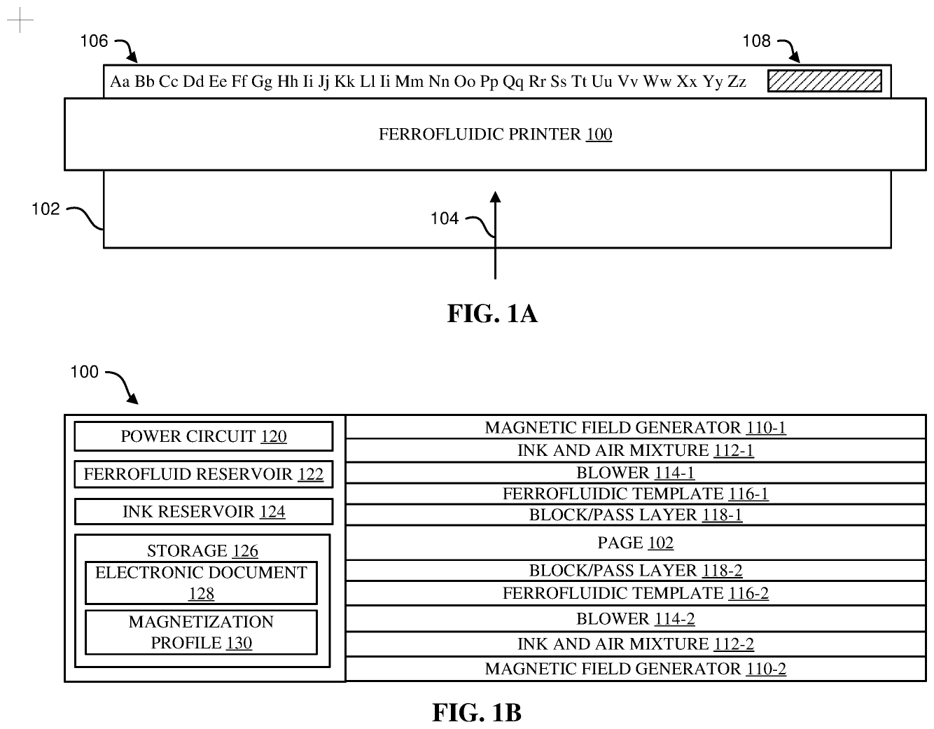

Referring now to the figures, FIG. 1A illustrates a top view of an example ferrofluidic printer 100 performing printing operations on a page 102, in accordance with some embodiments of the present disclosure. The page 102 can be any printing medium of any size that can fit within the dimensions of the ferrofluidic printer 100. The page 102 is fed into the ferrofluidic printer 100 in a direction of feed 104. The ferrofluidic printer 100 can print text 106 and/or an image 108 on the page 102. Although the text 106 and/or the image 108 are shown as black and white, the ferrofluidic printer 100 can additionally, or alternatively, print in color.

In some embodiments, the ferrofluidic printer 100 is less than or equal to approximately 305 millimeters (12 inches) wide by 51 millimeters (2 inches) tall by 51 millimeters (2 inches) long. In FIG. 1A, the “tall” dimension is not shown as FIG. 1A illustrates the top view of the ferrofluidic printer 100. In some embodiments, the page 102 is a standard size such as, for example, any one of sizes A0-A10. In some embodiments, the page 102 is paper, plastic, or a different printing medium.

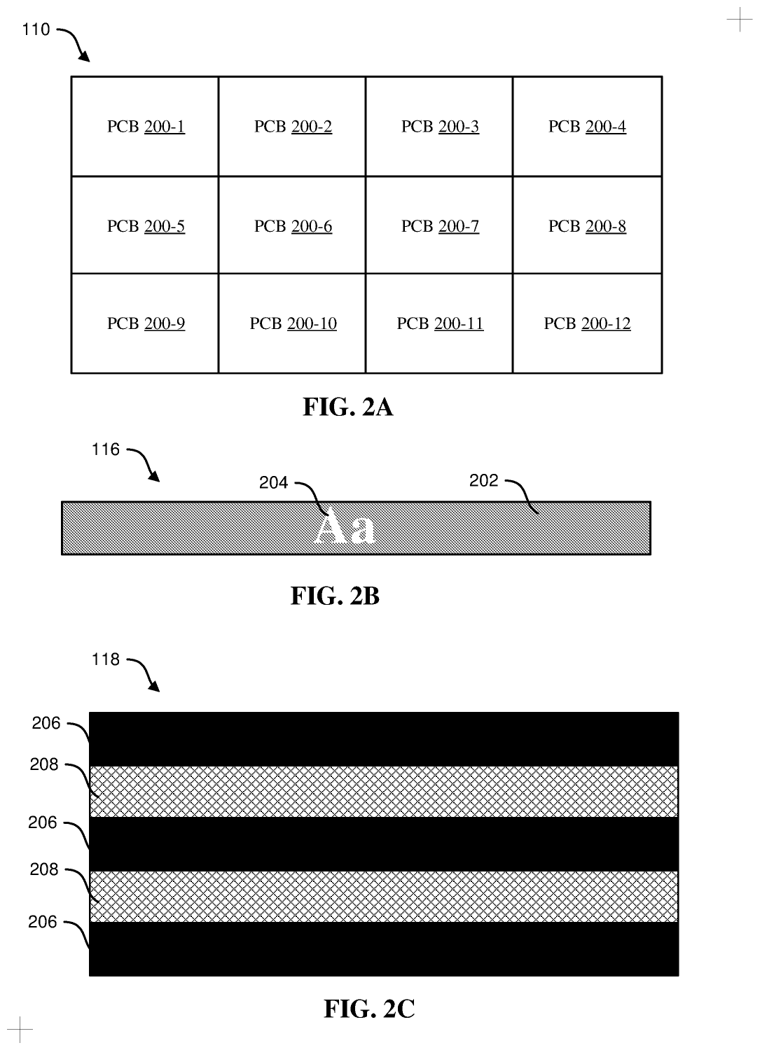

FIG. 1B illustrates some components of an example ferrofluidic printer 100, in accordance with some embodiments of the present disclosure. Ferrofluidic printer 100 includes magnetic field generator 110 (which can refer to either or both of an upper magnetic field generator 110-1 and/or a lower magnetic field generator 110-2). Magnetic field generator 110 is configured to form a ferrofluidic template 116 (which can refer to either or both of an upper ferrofluidic template 116-1 and/or a lower ferrofluidic template 116-2) by generating a magnetic field that arranges a ferrofluid into a geometry that approximates a portion of an electronic document 128. As can be seen, there can be two magnetic field generators 110 (e.g., 110-1 and 110-2), one for each side of page 102 in embodiments where ferrofluidic printer 100 is configured to simultaneously (e.g., contemporaneously) print double-sided. Magnetic field generator 110 can be made up of numerous inductors that can be collectively used to generate a tailored magnetic field. In some embodiments, the inductors are incorporated into printed circuit boards (PCBs). Magnetic field generator 110 is discussed in more detail hereinafter with respect to FIG. 2A.

Ferrofluidic printer 100 further includes ink and air mixture 112 (which can refer to either or both of an upper ink and air mixture 112-1 and/or a lower ink and air mixture 112-2). In some embodiments, the ink is dry ink in particle form and is conducive to being projected through the ferrofluidic template 116 by air. The dry ink can be made up of one or more solvents, pigments, dyes, resins, lubricants, solubilizers, surfactants, particulates, and/or fluorescents depending on the specific needs of the ferrofluidic printer 100. In embodiments where the ink and air mixture 112 is composed of dry particle pigments, the dry particle pigments can be in a range of approximately 0.1 to 2.0 micrometers in diameter. In some embodiments, the dry particle pigments can be less than one micrometer in diameter. In some embodiments, there are two ink and air mixtures 112 (e.g., 112-1 and 112-2), one for each side of the page 102 in embodiments configured for simultaneous, double-sided printing.

Ferrofluidic printer 100 further includes blower 114 (which can refer to either or both of an upper blower 114-1 and/or a lower blower 114-2). The blower 114 can be configured to project ink and air mixture 112 through ferrofluidic template 116 and onto page 102. In some embodiments, blower 114 is configured to project the ink and air mixture 112 at a speed of at least approximately two meters per second (6.56 feet per second). The blower 114 can be, but is not limited to, an axial-flow blower (e.g., a fan with blades oriented around a shaft, and where the fan is configured to move air in a direction parallel to the shaft), a centrifugal blower (e.g., a fan with spiral blades that is configured to project air at an approximately right angle from the fan's intake), a bladeless indirect viscous-shear blower (e.g., a fan configured to collect pressurized airflow using a standard fan mechanism and then project the air in a thin, high-velocity laminar flow by directing it through a hollow tube or toroid), and/or other blower mechanisms. In some embodiments, a centrifugal blower or a bladeless indirect viscous-shear blower are useful for generating relatively high air velocities relatively quickly, which can make them useful for applications such as the ferrofluidic printer 100 where quick bursts of air are useful for accurately projecting ink through the ferrofluidic template 116 and onto the page 102.

As shown in FIG. 1B, there are two blowers 114 on either side of page 102 in embodiments configured for simultaneous double-sided printing. In such embodiments, the lower blower 114-2 can be configured to project the lower ink and air mixture 112-2 through the lower ferrofluidic template 116-2 at a higher speed than the upper blower 114-1 projects the upper ink and air mixture 112-1 through the upper ferrofluidic template 116-1 in order to overcome the additional gravitational force counteracting the lower ink and air mixture 112-2 projected upwards by the lower blower 114-2 during printing operations.

Ferrofluidic printer 100 further includes a ferrofluidic template 116. The ferrofluidic template 116 can include a ferrofluid. The ferrofluid can be a colloidal liquid comprising ferromagnetic or ferrimagnetic particles that are suspended in a carrier fluid such as water or an organic solvent. The ferromagnetic or ferrimagnetic particles can be nanoscale sized particles or microscale sized particles in various embodiments. For example, in some embodiments, the ferromagnetic or ferrimagnetic particles are greater than 1 micrometer in diameter. In some embodiments, the ferromagnetic or ferrimagnetic particles are larger in diameter than the ink particles in ink and air mixture 112. Examples of ferromagnetic particles include, but are not limited to, iron, cobalt, nickel, alloys thereof, rare earth metals, and so on. Examples of ferrimagnetic particles include, but are not limited to, ferrites, magnetic garnets, magnetite, yttrium iron garnet, cubic ferrites including iron oxides with another element (such as aluminum, cobalt, nickel, manganese, or zinc), hexagonal ferrites (such as PbFe₁₂O₁₉, BaFe₁₂O₁₉, or pyrrhotite), and so on. In some embodiments, the ferromagnetic or ferrimagnetic particles are coated in a surfactant (e.g., oleic acid, tetramethylammonium hydroxide, citric acid, soy lecithin, or others) to reduce clumping. Although ferrofluids are discussed above, other embodiments can include magnetorheological fluids or another fluid that can be manipulated by a magnetic field to form a template useful for printing a portion of an electronic document 128. Ferrofluidic template 116 is discussed in more detail below with respect to FIG. 2B.

Ferrofluidic printer 100 further includes a block/pass layer 118 (which can refer to either or both of an upper block/pass layer 118-1 and/or a lower block/pass layer 118-2). The block/pass layer 118 is configured to provide a solid blocking layer (e.g., a block mode) while the ferrofluid is in a de-magnetized state (e.g., a liquid state or a state with relatively low viscosity) and provide a sieved passing layer (e.g., a pass mode) while the ferrofluid is in a magnetized state (e.g., a solid state or a state with relatively high viscosity). The pass layer can include a net-like, permeable, or semi-permeable medium that the ink and air mixture 112 can traverse to the page 102. In some embodiments, the pass layer includes gaps approximately 0.01 to 2.00 micrometers in diameter. Meanwhile, the pass layer is generally impermeable to the ferrofluid making up ferrofluidic template 116. As a result, the block/pass layer 118 can be useful for reducing possible contamination of ferrofluid on the page 102 during printing operations.

Ferrofluidic printer 100 further includes a power circuit 120 configured to provide electricity to the ferrofluidic printer 100. The power circuit 120 can be configured to supply electricity to the magnetic field generator 110 to generate a magnetic field. In some embodiments, power circuit 120 provides a respective electrical current to respective PCBs of the magnetic field generator 110 for producing a particular magnetic field. The power circuit 120 is further configured to provide electricity to blower 114 to project the ink and air mixture 112 through the ferrofluidic template 116. The power circuit 120 can be further configured to actuate rollers (not shown) for feeding the page 102 through the ferrofluidic printer 100.

Ferrofluidic printer 100 further includes a ferrofluid reservoir 122 for recharging ferrofluid to the ferrofluidic template 116 as needed. Likewise, ferrofluidic printer 100 further includes an ink reservoir 124 for recharging ink to ink and air mixture 112 as needed. In some embodiments, ink reservoir 124 includes a variety of colors of ink for color printing.

Ferrofluidic printer 100 further includes storage 126 including electronic document 128 and magnetization profile 130. Storage 126 can be any computer-readable storage medium such as, for example, a hard disk drive. Electronic document 128 can be, for example, a document file, a text file, an image file, or a different file configured for being printed using ferrofluidic printer 100. In various embodiments, the electronic document 128 can have a file format of, for example, .jpeg, .jpg, .tif, .gif, .bmp, .pdf, .doc, .docx, .xlsx, .ppt, .pptx, and so on. The magnetization profile 130 can include parameters for replicating text and/or images from electronic document 128 into a ferrofluidic template 116 created by a particular magnetic field generated by magnetic field generator 110.

In some embodiments, electronic document 128 is received from a user device (e.g., a smartphone, a laptop, a tablet, a wearable device, etc.) via a network interface (not shown) that maintains a short-range network enabling communication between the ferrofluidic printer 100 and the user device. In some embodiments, the short-range network can include, but is not limited to, any Wireless Personal Area Network (WPAN) such as, but not limited to, networks using ANT® or ANT-F® (registered trademarks of Garmin Switzerland GmbH) communication protocols, Bluetooth® (a registered trademark of Bluetooth Sig, Inc.) connections (e.g., connection protocols complying with Institute of Electric and Electronics Engineers (IEEE) 802.15.1), cellular radio transmission protocols, connection protocols complying with IEEE 802.15.4 (e.g., International Society of Automation (ISA) 100, Wireless Highway Addressable Remote Transducer (HART), ZigBee, 6LoPAN, etc.), infrared communication protocols, near-field communication (NFC) protocols, radio-frequency identification (RFID), Ultra-Wideband (UWB), and/or other WPAN technology. In some embodiments, the short-range network communicatively couples ferrofluidic printer 100 to other user devices within a given radius of ferrofluidic printer 100, where the radius can be less than 100 feet, less than 50 feet, less than 30 feet, less than 10 feet, or a different radius.

Although not shown, in some embodiments, the ferrofluidic printer 100 includes a cooling mechanism (e.g., a circuit configured to realize the Peltier effect by removing heat from its surroundings). The cooling mechanism can cause condensation to attach to the ink particles in the ink and air mixture 112 to promote adhesion of the ink particles to the page 102. In some embodiments, the cooling mechanism can be coupled to the blower 114, the ferrofluidic template 116, the block/pass layer 118, or a different portion of ferrofluidic printer 100.

FIGS. 1A and 1B are shown for illustrative purposes and embodiments of the present disclosure exist that utilize all, some, and/or different components than the components illustrated in FIGS. 1A and 1B. Furthermore, the dimensions (literal or relative) shown in FIGS. 1A and 1B are illustrative and non-limiting. Further still, the arrangement of components in FIGS. 1A and 1B are illustrative and non-limiting. As an example, although the power circuit 120, ferrofluid reservoir 122, ink reservoir 124, and storage 126 are shown on the left side of ferrofluidic printer 100 in FIG. 1B, this is purely for illustration. The aforementioned components can be included anywhere within ferrofluidic printer 100 or be coupled to the ferrofluidic printer 100, if they are included at all. Further, the arrangement of magnetic field generator 110, ink and air mixture 112, blower 114, ferrofluidic template 116, and block/pass layer 118 are shown for illustrative purposes and are non-limiting. In other embodiments, these components can be arranged in different orders or incorporated into one another, if included at all.

Referring now to FIG. 2A, illustrated is an example magnetic field generator 110, in accordance with some embodiments of the present disclosure. As shown in FIG. 2A, the magnetic field generator 110 can comprise a plurality of printed circuit boards (PCBs) 200-1 to 200-12 (collectively referred to as PCB 200) where each PCB 200 includes coils configured to generate a magnetic field in response to receiving an electrical current. In other words, each of the PCBs 200 can be configured to function as an inductor. Further, characteristics of the magnetic field generated by all PCBs 200 can be tailored based on different electrical currents provided to different PCBs 200 at different times. Although FIG. 2A illustrates twelve PCBs 200, more or fewer PCBs 200 are also possible and they can be placed in similar or different arrangements than the arrangement shown. Further, individual PCBs 200 can have a variety of sizes such as, for example, the millimeter-scale, the centimeter-scale, a larger scale, or a smaller scale. Further still, in various embodiments, the plurality of PCBs 200 can refer to separate components of a single PCB, or the plurality of PCBs 200 can represent discrete PCBs.

PCBs 200 can be, for example, spiral PCB inductors that are designed to achieve predetermined magnetic field capabilities based on a number of metal (e.g., copper) layers, a spacing between metal layers, a metal width, and a number of turns, among other possible design factors. The design of such spiral PCB inductors can be aided with computer software, such as, for example Sonnet® (a registered trademark of Sonnet Software, Inc.).

Referring now to FIG. 2B, illustrated is an example ferrofluidic template 116, in accordance with some embodiments of the present disclosure. Ferrofluidic template 116 includes a ferrofluid 202 that is manipulated by the magnetic field generator 110 to create an opening 204 approximating document text or a layer of an image. Although the opening 204 is shown extending through the thickness of the ferrofluidic template 116, in other embodiments the ferrofluid 202 is manipulated in the z-dimension (into and out of the page) to create gaps or cavities by which ink can be projected onto the page 102 via non-orthogonal trajectories.

Referring now to FIG. 2C, illustrated is an example block/pass layer 118. The block/pass layer 118 can include a block mode 206 and a pass mode 208. As shown in FIG. 2C, there are three block modes 206 and two pass modes 208, however, this is only one example and in other embodiments there are at least one block mode 206 and at least one pass mode 208. Block mode 206 is used to hold a ferrofluid in a de-magnetized, liquid state and prevent it from contaminating page 102. In some embodiments, block mode 206 is impermeable to particles in ferrofluidic template 116 and ink particles in ink and air mixture 112.

In contrast, pass mode 208 is used to transport ink particles to the page 102 when the ferrofluid is in a magnetized, semi-solid state. The pass mode 208 can be a net, sieve, lattice, or other permeable membrane capable of allowing the ink and air mixture 112 to be blown through the ferrofluidic template 116, through the pass mode 208 of the block/pass layer 118, and onto the page 102. The pass mode 208 can include holes, gaps, cavities, tunnels, and/or other geometries enabling ink particles to cross the permeable layer. While the pass mode 208 is generally permeable to ink particles in ink and air mixture 112, the pass mode 208 is generally impermeable to ferromagnetic or ferrimagnetic particles forming ferrofluidic template 116.

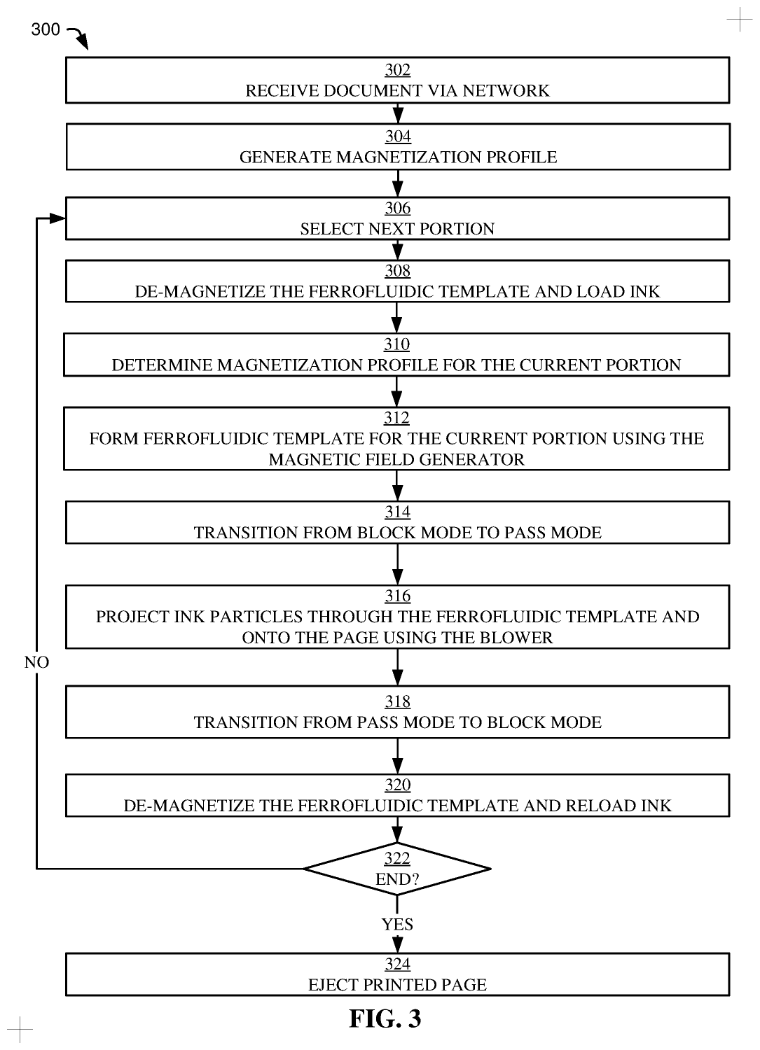

Referring now to FIG. 3, illustrated is a flowchart of an example method 300 for performing ferrofluidic printing, in accordance with some embodiments of the present disclosure. The method 300 can be performed by a ferrofluidic printer 100, a computer 500, or a different configuration of hardware and/or software.

Operation 302 includes receiving an electronic document 128 for printing. In some embodiments, the electronic document 128 is received from a user device via a short-range network. Although not explicitly shown, operation 302 can include establishing a short-range network connection with a user device using one or more of the short-range network protocols previously discussed. As will be appreciated by one skilled in the art, other networks, such as wide-area networks (WAN) or the Internet can also be used to transfer the electronic document 128 from a user device to the ferrofluidic printer 100. The electronic document 128 can include text, images, or a combination of text and images. Likewise, the electronic document 128 can include elements in black, grayscale, and/or color.

Operation 304 includes generating a magnetization profile 130 based on the electronic document 128. The magnetization profile 130 can include information regarding feed speed for page 102, parameters for magnetic field generator 110 (e.g., a time and amount of electrical current to provide to various inductors within the magnetic field generator 110), an amount of ink (and color of ink, if applicable) from ink reservoir 124 to include in ink and air mixture 112, an amount of ferrofluid from ferrofluid reservoir 122 to include in ferrofluidic template 116, an air speed for blower 114, transitions between block mode 206 and pass mode 208 for block/pass layer 118, and/or other parameters.

Operation 306 includes selecting a next portion (or first portion) of the electronic document 128 for printing. In some embodiments, operation 306 includes selecting a line of text (or multiple lines of text) for printing. The size of the portion selected for printing in operation 306 depends on, for example, the dimensions of the ferrofluidic template 116, blower 114, and/or magnetic field generator 110, the printing resolution, and/or the nature of the electronic document 128 (e.g., image, text, etc.).

Operation 308 includes de-magnetizing the ferrofluidic template 116 and loading ink and air mixture 112 with the appropriate amount and type of ink. De-magnetizing the ferrofluidic template 116 can include removing any magnetic field created by magnetic field generator 110.

Operation 310 includes determining magnetization profile 130 for the current portion of the electronic document 128. In some embodiments, the magnetization profile 130 includes an amount of electrical current to supply to respective PCBs 200 to generate a magnetic field configured to approximate the current portion of the electronic document 128.

Operation 312 includes forming the ferrofluidic template 116 for the current portion of the electronic document 128 using a magnetic field created by the magnetic field generator 110. Operation 314 includes transitioning the block/pass layer 118 from block mode 206 to pass mode 208.

Operation 316 includes projecting ink particles of the ink and air mixture 112 through the ferrofluidic template 116 and onto the page 102 using the blower 114. In some embodiments, the ink particles are projected at a predetermined velocity and for a predetermined period of time. For example, the ink particles can be projected by the blower at a velocity greater than or equal to approximately two meters per second (6.56 feet per second) for less than or equal to two seconds.

In some embodiments, the blower 114 (or a different aspect of ferrofluidic printer 100) further acts a cooler so that condensation forms on the ink particles, thereby improving adhesion of the ink particles to the page 102. In these embodiments, a circuit can be included adjacent to the blower 114 (or another portion of the ferrofluidic printer 100) that is capable of realizing the Peltier effect (e.g., when supplied with power, the operating circuit removes heat from its surroundings).

Operation 318 includes transitioning the block/pass layer 118 from pass mode 208 to block mode 206. Operation 320 includes de-magnetizing the ferrofluidic template 116 and reloading the ink and air mixture 112 with additional ink if needed. De-magnetizing the ferrofluidic template 116 can include ending the magnetic field by not providing electrical current to the magnetic field generator 110.

Operation 322 determines if the current portion of the electronic document 128 is the final portion of the electronic document 128. If so, (322: YES), the method 300 proceeds to operation 324 and ejects the printed page 102. If not, (322: NO), the method 300 returns to operation 306 and selects a next portion of the electronic document 128 for printing.

In embodiments utilizing double-sided printing, operations 306-322 can proceed simultaneously for the top-side and the underside of the page 102. However, at operation 316, the lower blower 114-2 configured to project ink particles onto the underside of the page 102 can be configured to project the ink particles at a higher velocity than the upper blower 114-1 configured to project ink particles onto the top side of the page 102. For example, the lower blower 114-2 can be configured to project ink particles at a speed equal to or greater than 3 meters per second (9.84 feet per second).

The aforementioned operations can be completed in any order and are not limited to those described. Additionally, some, all, or none of the aforementioned operations can be completed, while still remaining within the spirit and scope of the present disclosure.

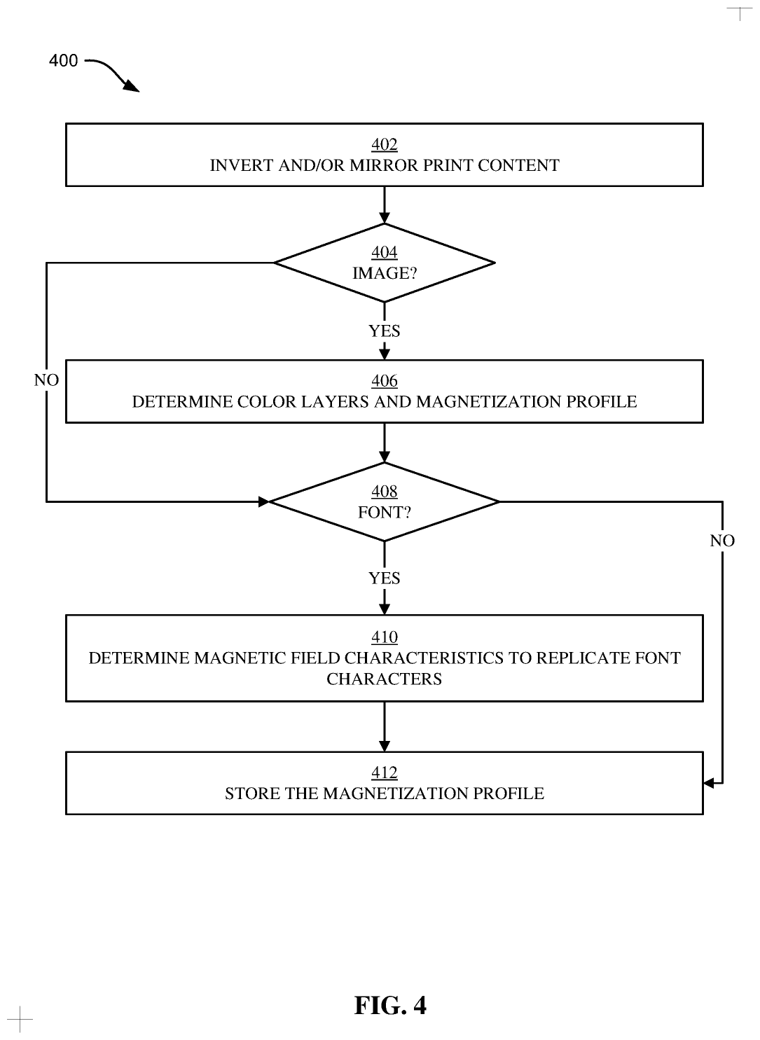

Referring now to FIG. 4, illustrated is a flowchart of an example method 400 for generating a magnetization profile 130, in accordance with some embodiments of the present disclosure. The method 400 can be performed by a ferrofluidic printer 100, a computer 500, or a different configuration of hardware and/or software. In some embodiments, the method 400 is a sub-method of operation 304 of the method 300.

Operation 402 includes inverting and/or mirroring portions of the electronic document 128 that will be printed on the reverse side of the page 102. Inverting and/or mirroring portions of the electronic document 128 can be performed using algorithms, processes, and techniques understood by one skilled in the art. In embodiments where the content on the top side and reverse side of the page 102 are independent (e.g., two consecutive pages of a document, each page containing different material) then the relevant content for the reverse side may be inverted or otherwise manipulated so that the fully printed page contains content on each side in the correct orientation. In other embodiments, the two copies of the same content can be printed by providing two pages 102 to the ferrofluidic printer 100 and mirroring the content for the top side to the reverse side so that two approximately identical copies are simultaneously printed by the ferrofluidic printer 100.

Operation 404 includes determining if the electronic document 128 is an image (or includes an image). Operation 404 can identify an image based on, for example, a file format of the electronic document 128, image recognition algorithms, and/or metadata associated with the electronic document 128. If the electronic document 128 does include an image, (404: YES), the method 400 proceeds to operation 406. If the electronic document 128 does not include an image (404: NO), the method 400 proceeds to operation 408.

Operation 406 includes determining color layers and magnetic fields for each layer for an image in electronic document 128. Operation 406 can utilize image parsing techniques utilized by other printing technologies to determine a layer-by-layer color scheme useful for replicating an image. The method 400 then proceeds to operation 408.

Operation 408 includes determining if the electronic document 128 includes font (or any text-like characters). Operation 408 can determine if the electronic document 128 includes font based on, for example, a file format of the electronic document 128, optical character recognition (or other machine algorithms useful for identifying font), metadata associated with the electronic document 128, or different techniques. If the electronic document 128 does not include font, (408: NO), the method 400 proceeds to operation 412. If the electronic document 128 does include font, (408: YES), the method 400 proceeds to operation 410.

Operation 410 includes determining a magnetic field to replicate each character of font. Operation 410 can determine the magnetic field based on known properties of the magnetic field generator 110 and the ferrofluid used to form ferrofluidic template 116. The method 400 then proceeds to operation 412. Operation 412 stores the magnetization profile 130 generated in operations 402-410 in storage 126.

The aforementioned operations can be completed in any order and are not limited to those described. Additionally, some, all, or none of the aforementioned operations can be completed, while still remaining within the spirit and scope of the present disclosure.

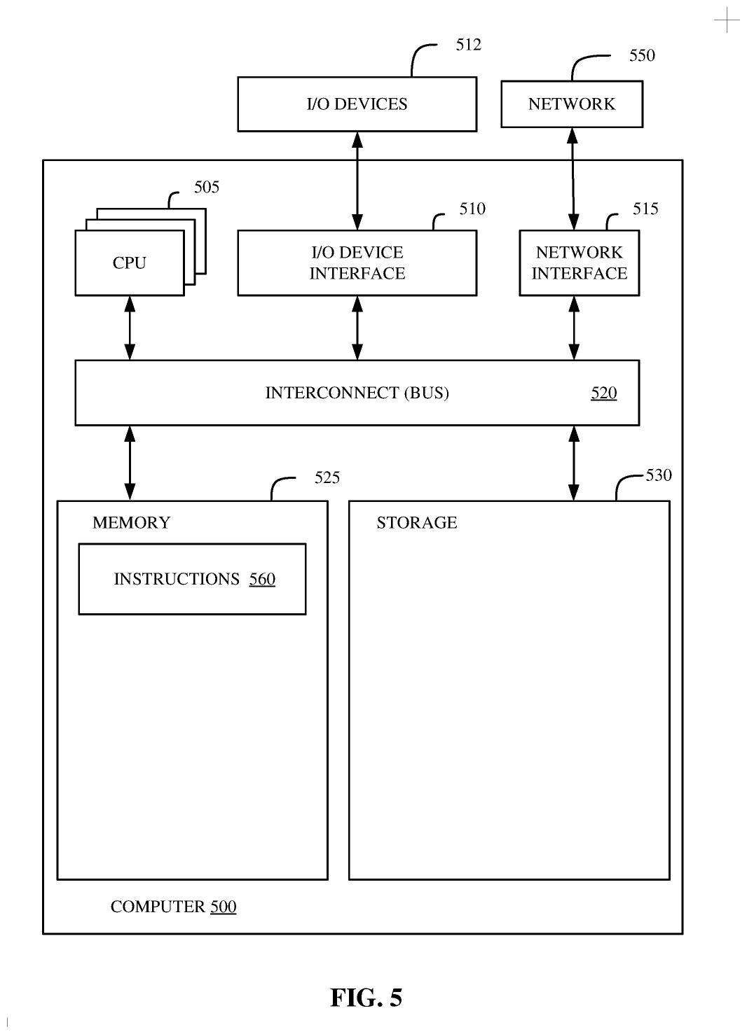

FIG. 5 illustrates a block diagram of an example computer 500 in accordance with some embodiments of the present disclosure. In various embodiments, computer 500 can perform the methods described in FIGS. 3-4 and/or implement the functionality discussed in FIGS. 1A-1B and 2A-2C. In some embodiments, computer 500 receives instructions related to the aforementioned methods and functionalities by downloading processor-executable instructions from a remote data processing system via network 550. In other embodiments, computer 500 provides instructions for the aforementioned methods and/or functionalities to a client machine such that the client machine executes the method, or a portion of the method, based on the instructions provided by computer 500. In some embodiments, the computer 500 is incorporated into ferrofluidic printer 100.

Computer 500 includes memory 525, storage 530, interconnect 520 (e.g., BUS), one or more CPUs 505 (also referred to as processors herein), I/O device interface 510, I/O devices 512, and network interface 515.

Each CPU 505 retrieves and executes programming instructions stored in memory 525 or storage 530. Interconnect 520 is used to move data, such as programming instructions, between the CPUs 505, I/O device interface 510, storage 530, network interface 515, and memory 525. Interconnect 520 can be implemented using one or more busses. CPUs 505 can be a single CPU, multiple CPUs, or a single CPU having multiple processing cores in various embodiments. In some embodiments, CPU 505 can be a digital signal processor (DSP). In some embodiments, CPU 505 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 525 is generally included to be representative of a random-access memory (e.g., static random-access memory (SRAM), dynamic random access memory (DRAM), or Flash). Storage 530 is generally included to be representative of a non-volatile memory, such as a hard disk drive, solid state device (SSD), removable memory cards, optical storage, or flash memory devices. In an alternative embodiment, storage 530 can be replaced by storage area-network (SAN) devices, the cloud, or other devices connected to computer 500 via I/O device interface 510 or network 550 via network interface 515.

In some embodiments, memory 525 stores instructions 560. However, in various embodiments, instructions 560 are stored partially in memory 525 and partially in storage 530, or they are stored entirely in memory 525 or entirely in storage 530, or they are accessed over network 550 via network interface 515.

Instructions 560 can be processor-executable instructions for performing any portion of, or all of, any of the methods of FIGS. 3-4 and/or implementing any of the functionality discussed in FIGS. 1A-1B and 2A-2C.

In various embodiments, I/O devices 512 include an interface capable of presenting information and receiving input. For example, I/O devices 512 can present information to a user interacting with computer 500 and receive input from the user.

Computer 500 is connected to network 550 via network interface 515. Network 550 can comprise a physical, wireless, cellular, or different network.

Embodiments of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 560 of FIG. 5 and/or any software configured to perform any subset of the methods described with respect to FIGS. 3-4 and/or any of the functionality discussed in FIGS. 1A-1B and 2A-2C) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

Several examples will now be provided to further clarify various aspects of the present disclosure.

Example 1: A method comprising receiving an electronic document at a ferrofluidic printer from a user device via a short-range network; applying a magnetic field to a ferrofluid to form a ferrofluidic template approximating a portion of the electronic document; and projecting ink through the ferrofluidic template and onto a page using a blower.

Example 2: The limitations of example 1, wherein the magnetic field is formed by respective electrical currents provided to a plurality of printed circuit boards, the plurality of printed circuit boards respectively configured to function as inductors.

Example 3: The limitations of any one of Examples 1-2, wherein the blower is configured to generate an air speed of greater than or equal to two meters per second (6.56 feet per second).

Example 4: The limitations of any one of Examples 1-3, wherein the blower is selected from a group consisting of: a centrifugal blower, and a bladeless indirect viscous-shear blower.

Example 5: The limitations of any one of Examples 1-4, further comprising, contemporaneously with projecting ink through the ferrofluidic template, projecting ink through a second ferrofluidic template on a reverse side of the page using a second blower.

Example 6: The limitations of any one of Examples 1-5, the projecting ink through the ferrofluidic template further comprising cooling the ink using a circuit configured to realize a Peltier effect.

Example 7: The limitations of any one of Examples 1-6, further comprising transitioning a block/pass layer from a block mode to a pass mode prior to projecting ink through the ferrofluidic template; and transitioning the block/pass layer from the pass mode to the block mode after projecting ink through the ferrofluidic template.

Example 8: The limitations of Example 7, wherein the block mode is impermeable to the ferrofluid and the ink, and wherein the pass mode is impermeable to the ferrofluid and permeable to the ink.

Example 9: The Limitations of any one of Examples 7-8, wherein the permeable layer includes holes that are less than or equal to 2 micrometers in diameter.

Example 10: The limitations of any one of Examples 1-9, wherein the ferrofluidic printer is less than or equal to 305 millimeters long (twelve inches long), less than or equal to 51 millimeters tall (two inches tall), and less than or equal to 51 millimeters wide (two inches wide).

Example 11: A ferrofluidic printer comprising (1) a magnetic field generator configured to generate a magnetic field; (2) a ferrofluidic template comprising a ferrofluid and configured to approximate a portion of an electronic document in response to the magnetic field; (3) a blower configured to project ink particles through the ferrofluidic template; and (4) a block/pass layer configured to transition from a block mode to a pass mode after the magnetic field is generated and before the blower projects the ink particles through the ferrofluidic template.

Example 12: The limitations of Example 11, wherein the magnetic field generator comprises a plurality of printed circuit boards configured to function as inductors.

Example 13: The limitations of any one of Examples 11-12, the ferrofluidic printer further comprising a cooling circuit configured to cause condensation to form on the ink particles.

Example 14: The limitations of any one of Examples 11-13, wherein the blower is a bladeless indirect viscous-shear blower.

Example 15: The limitations of any one of Examples 11-13, wherein the blower is a centrifugal blower.

Example 16: The limitations of any one of examples 11-15, wherein the block mode of the block/pass layer is impermeable to the ferrofluid and the ink particles, wherein the pass mode of the block/pass layer is impermeable to the ferrofluid and permeable to the ink particles.

Example 17: The limitations of any one of Examples 11-16, further comprising a network interface configured to establish network communication with a user device using a short-range network and receive the electronic document from the user device via the short-range network.

Example 18: The limitations of any one of Examples 11-17, wherein the ink particles comprise pigment particles, and wherein the ferrofluid comprises ferromagnetic particles, and wherein the pigment particles are smaller than the ferromagnetic particles.

Example 19: The limitations of Example 18, wherein the pigment particles are less than or equal to one micrometer in diameter, and wherein the ferromagnetic particles are greater than one micrometer in diameter.

Example 20: A computer program product comprising a computer readable storage medium having program instructions embodied therewith, the program instructions executable by a ferrofluidic printer to cause the ferrofluidic printer to perform operations associated with any one of Examples 1-10.

Example 21: A system comprising a processor and a computer-readable storage medium storing program instructions, wherein the processor is configured to execute the program instructions to perform operations associated with any one of Examples 1-10.

What is claimed is:

1. A method comprising:
receiving an electronic document at a ferrofluidic printer from a user device via a short-range network;
applying a magnetic field to a ferrofluid to form a ferrofluidic template approximating a portion of the electronic document; and
projecting ink through the ferrofluidic template and onto a page using a blower.

2. The method of claim 1, wherein the magnetic field is formed by respective electrical currents provided to a plurality of printed circuit boards, the plurality of printed circuit boards respectively configured to function as inductors.

3. The method of claim 1, wherein the blower is configured to generate an air speed of greater than or equal to two meters per second (6.56 feet per second).

4. The method of claim 1, wherein the blower is selected from a group consisting of: a centrifugal blower, and a bladeless indirect viscous-shear blower.

5. The method of claim 1, further comprising:
contemporaneously with projecting ink through the ferrofluidic template, projecting ink through a second ferrofluidic template on a reverse side of the page using a second blower.

6. The method of claim 1, the projecting ink through the ferrofluidic template further comprising:
cooling the ink using a circuit configured to realize a Peltier effect.

7. The method of claim 1, the method further comprising:
transitioning a block/pass layer from a block mode to a pass mode prior to projecting ink through the ferrofluidic template; and
transitioning the block/pass layer from the pass mode to the block mode after projecting ink through the ferrofluidic template.

8. The method of claim 7, wherein the block mode is impermeable to the ferrofluid and the ink, and wherein the pass mode is impermeable to the ferrofluid and permeable to the ink.

9. The method of claim 8, wherein the pass mode includes holes that are less than or equal to 2 micrometers in diameter.

10. The method of claim 1, wherein the ferrofluidic printer is less than or equal to 305 millimeters long (twelve inches long), less than or equal to 51 millimeters tall (two inches tall), and less than or equal to 51 millimeters wide (two inches wide).

11. A ferrofluidic printer comprising:
a magnetic field generator configured to generate a magnetic field;
a ferrofluidic template comprising a ferrofluid and configured to approximate a portion of an electronic document in response to the magnetic field;
a blower configured to project ink particles through the ferrofluidic template; and
a block/pass layer configured to transition from a block mode to a pass mode after the magnetic field is generated and before the blower projects the ink particles through the ferrofluidic template.

12. The ferrofluidic printer of claim 11, wherein the magnetic field generator comprises a plurality of printed circuit boards configured to function as inductors.

13. The ferrofluidic printer of claim 11, further comprising a cooling circuit configured to cause condensation to form on the ink particles.

14. The ferrofluidic printer of claim 11, wherein the blower is a bladeless indirect viscous-shear blower.

15. The ferrofluidic printer of claim 11, wherein the blower is a centrifugal blower.

16. The ferrofluidic printer of claim 11, wherein the block mode is impermeable to the ferrofluid and the ink particles, wherein the pass mode is impermeable to the ferrofluid and permeable to the ink particles.

17. The ferrofluidic printer of claim 11, further comprising a network interface configured to establish network communication with a user device using a short-range network and receive the electronic document from the user device via the short-range network.

18. The ferrofluidic printer of claim 11, wherein the ink particles comprise pigment particles, and wherein the ferrofluid comprises ferromagnetic particles, and wherein the pigment particles are smaller than the ferromagnetic particles.

19. The ferrofluidic printer of claim 18, wherein the pigment particles are less than or equal to one micrometer in diameter, and wherein the ferromagnetic particles are greater than one micrometer in diameter.

20. A computer program product comprising a computer readable storage medium having program instructions embodied therewith, the program instructions executable by a ferrofluidic printer to cause the ferrofluidic printer to perform a method comprising:
receiving an electronic document at a ferrofluidic printer from a user device via a short-range network;
applying a magnetic field to a ferrofluid to form a ferrofluidic template approximating a portion of the electronic document; and
projecting ink through the ferrofluidic template and onto a page using a blower.
